(19) United States
(12) Patent Application Publication
(10) Pub. No.: US 2004/0102238 A1
(43) Pub. Date: May 27, 2004

(54) Method for session play gambling games

(76) Inventor: William A. Taylor, Evergreen, CO (US)

Correspondence Address: SHERIDAN ROSS PC, 1560 BROADWAY, SUITE 1200, DENVER, CO, 80202

(21) Appl. No.: 10/719,344

(22) Filed: Nov. 21, 2003

Related U.S. Application Data
(63) Continuation-in-part of application No. 10/095,795, filed on Mar. 11, 2002.
(60) Provisional application No. 60/428,439, filed on Nov. 22, 2002.
(60) Provisional application No. 60/275,128, filed on Mar. 13, 2001.

(51) Int. Cl. A63F 13/00

(52) U.S. Cl. 463/16

(57) ABSTRACT

A method for wagering on a gaming device where players purchase a play session with a predetermined period of time as opposed to an individual game. Within the pre-purchased time period, players are allowed to play as many individual games as possible to maximize their returns. In one embodiment, the session time is variable wherein play is ended when a predetermined number of game termination events occur.

This application claims priority to U.S. Provisional Application Serial No. 60/428,439, filed Nov. 22, 2002, and is a continuation-in-part of U.S. patent application Ser. No. 10/095,795, filed Mar. 11, 2002, both of which are incorporated by reference in their entirety herein.

### FIELD OF THE INVENTION

The present invention relates to gaming machines generally, more specifically to methods of wagering on gaming machines for a predetermined or variable period of time.

### BACKGROUND OF THE INVENTION

Gambling devices, such as slot machines, allow players to wager something of value in the hopes of winning something of greater value. Traditionally, slot machines are mechanical devices employing three physical reels with various symbols painted or affixed thereto. Upon inserting a coin and pulling a spring-loaded handle, the reels were set in motion and players were paid (or not) depending upon where the reels stopped, and which symbols were displayed across a payline on a display portion of the machine.

Many slot machines utilized today are computer based, and the symbols are displayed in video form. Players increasingly prefer video display slot machines over the traditional slot machines using mechanical reels. The video platform also offers more flexibility in development for manufacturers. The common term today for a gambling machine is a “gaming device”, and is used herein to include slot machines, video poker, and other gambling games whether reel, video, or otherwise.

Video slots machines often display five reels oriented in side-by-side relationship that spin on a common axis instead of the traditional three (or more) mechanical reels. These newer video slots usually show three stopping positions of each reel yielding a visible matrix of three rows by five columns. As appreciated by one skilled in the art, sometimes the number of reels and reel positions displayed differ.

Players typically wager on one or more paylines that run in different paths through the reel positions displayed. Unlike newer models of gaming devices, early slots paid only for matching symbols straight across the center (a single payline). The path of each payline usually takes one adjacent position of each reel, so on a five-reel game the payline is usually five positions in length. Players may wager on multiple paylines and may even wager multiple credits per payline. Reel symbols occurring in various combinations on the paylines are compared to a predetermined payable combination to determine a win or loss. Often there are wild symbols that substitute for other symbols, and symbol combinations that trigger a bonus or feature game. Today, gaming machines may provide scattered pays, where certain symbol(s) pay anywhere in the visible display and are not required to occur on a payline. Traditionally, wins are rewarded with monetary payouts from a coin hopper provided on the machine.

Additional screen features are now common in gaming machines. For example, a bonus second-screen game is usually separate and distinct from the normal reel display, wherein a player might select a car in a car race or scratch from a selection of video lottery tickets to earn credits, free games, or anything of value. Some games even offer third screens or more, enhancing player interest and intrigue.

Playing consecutive games is often desirous to the gaming consumer. Some players have found ways to play consecutive games without manual intervention. For example, sometimes players use a toothpick or folded matchbook cover in such a manner as to keep the play button depressed. Provided they have sufficient credits, consecutive games play off by themselves. Although these players have basically fashioned an autoplay device, each game is still a single, discrete event that requires a separate wager. The problem with this type of autoplay is that it is not interactive. By definition, what autoplay offers players is the ability to gamble largely without human intervention described in U.S. Pat. Nos. 6,244,957 and 6,012,983 to Walker, et al. In fact, once started, an autoplay player need not even watch the game, much less become involved with it. In general, the more interactive a gaming device is, the greater its entertainment value and more players will pay to play it. Autoplay does not offer the same excitement of playing manually. Thus, a serious shortcoming of autoplay-type games is their lower entertainment value and the smaller set of players that enjoy such a decidedly non-interactive gaming experience.

Other types of gaming devices offer side bets. For example, as disclosed in U.S. Pat. No. 6,283,474 to de Keller, players play blackjack, but may wager separately who gets closest to a “21” point score. Similarly, in US. Pat. No. 6,019,374 to Breeding, a gaming device is provided which offers a side bet to participate in a super jackpot game. Side bets are just additional bets, and they are also discrete in that they are separate wagers on separate events.

Similarly, some gaming devices offer multiple bets. Triple play poker as described in U.S. Pat. No. 5,823,873 to Moody allows a player's held cards to be played as multiple poker hands with each draw performed independently, which usually results in three different outcomes. The drawback is each additional hand requires an additional wager, which can quickly become an expensive game for a typical player.

Regardless of the type or form of gaming device, whether reel slot, video game or some other type or combination, the method of wagering has remained largely the same for years. The player inserts coins or otherwise obtains credits on a machine, commits a wager and initiates play, and then is paid or not depending on the outcome. Although many new games are played today, the wagering methods are still based upon games that pay players directly in response to a single wager.

Slot machines generally allow play in many different denominations. Credits on one machine might be worth 1 cent, while others are worth $100. Some machines today even allow you to select the denomination within the machine and to change it between games. One recent advance in slot machine technology has been the introduction of a credit meter. With a credit meter, a player is able to insert more coins than were needed to play a single game, and thus have a pool of funds to draw upon. For example, ten nickels inserted would yield ten credits, wherein the player could play one game that required ten nickel credits, ten games that required one nickel credit each, or any combination thereof. The use of a credit meter also allows winnings to be accumulated on the machine, instead of always being paid out in coins each time the player won. A player may accumulate credits and then choose to cash out at their leisure by the use of a special button on the machine.

In the 1980s and 1990s, slot machine manufacturers began adding currency acceptors to their machines. Players may now obtain machine credits by simply inserting paper currency. In recent years, manufacturers have even added devices that dispense currency instead of, or in addition to, coins (these are known as note hoppers and operate similar to bank cash machines or ATMs). Further, many newer machines pay players in paper tickets or scripts that may be redeemed elsewhere or reinserted into the same or similar machines that read and accept such paper. These are usually known as ticket-printer machines. Some machines may even interact with credit cards, other cards that have value or be linked to a player's bank or other account supporting electronic funds transfer.

As a promotion, casinos sometime configure certain slot machines for tournament play. Slot tournaments are player versus player competitions administered by casino staff. Players gain entry through a variety of means, such as achieving VIP status in the casino's players club, paying an entry fee or simply for signing up. In these tournaments, players with the highest credit scores receive something of value from the casino. Generally, no wager is required, and the slot machines are set to a free play mode where the goal is to get more credits than the other players. Players are not normally paid directly for credits earned. Tournaments are marketing programs and not gaming devices, but they are important because they generate enormous excitement in players, who enjoy to play as fast as they can. However, tournaments may also be an inconvenience to the casino, because they require significant staff oversight for setup and administration. In addition, they're only offered at certain times. If a player is not there at the right time, he or she is precluded from participation. Further, tournaments are generally heavily marketed, which means a lot of hype and attention is focused on player participants and onlookers, which may be intimidating for those who prefer to play solo and/or out of the limelight.

Although many methods exist today for the player to obtain and retain credits or otherwise enable a slot machine for play, each game is a single and discrete event that is initiated one at a time, usually by pressing a button or pulling a handle. Generally, each game costs a certain amount to play and unless a player has sufficient credits to continue after a loss, another game cannot be played, thus extremely limiting the time allowed on a particular gaming device.

Time on a particular device is an important factor in the gaming industry today. Time on device is important not only for direct profits to gaming device operators, but also indirectly. The more time spent in one gambling property means more profit opportunities for the casino. Restaurants, shows, gift shops, hotel rooms, etc., all give the casino the chance for more profits. In general, the more time a player spends in a gaming establishment, the greater the likelihood they will return to spend additional money. Operators strive to keep the public in their establishment, which generally means more profits, and typically provide numerous incentives such as free or inexpensive food and drinks specifically for this purpose.

Marketing studies have revealed that players do not mind losing, as long as they can have a good time playing. Most casino gamblers don't really expect to win, but they do expect to play for a reasonable amount of time. This is entirely consistent with the gaming philosophy wherein gaming for the typical patron is more of an entertainment experience than a hardcore gambling experience. With the proliferation of casinos and gaming establishments in America over the past 20 years, casino gambling has become mainstream entertainment. Perhaps the most important part of that entertainment value is “time on device”, or how long you get to play for your money. Thus, time on device is critical to a positive gambling experience.

Accordingly, recent attempts have been made to ensure greater time on device for players. Perhaps the most common method today on slot machines is to employ a very high mathematical hit frequency and a reduced payable. Especially in the newer video slots, hit frequencies approach 50% or more. In practice, this means you might bet 10 coins per line on 9 paylines (90 coins total) only to win 20 coins. Even though this is clearly a net loss for the player, the 20 is still advertised as a win. This trickling back of credits to the player takes their money more slowly, recognizes them as winners (even if they're losing) and extends their play time for a given amount of money to bet.

One problem with high hit frequencies is that player returns become meaningless. While time on device is generally lengthened, betting 90 coins to win 20 coins eventually becomes tedious and boring. Players are not ignorant and do realize that in these types of gaming products, they are not really winning, even if the machine displays “winner”, but rather—they have simply lost less. The reduced payable means the allure of big winners is diminished. The tradeoff of more common winners is smaller winners.

Another problem of multi-line, multiple coin-per-line games is confusing math. For example, a player may bet four coins per line on seven paylines of a nickel game and win 2 for 1 on payline three and 3 for 1 on payline six. In this example the player loses because the original investment was $1.40 (28 nickels) for a return of $1.00 (20 nickels). This type of gaming configuration is confusing to most players, and assessing the outcome can slow down or significantly reduce play.

Thus, it is a long felt need in the field of gaming machines to provide a cost effective gaming device that guarantees a minimum amount of time for a player. The following disclosure describes an improved gaming machine that employs a novel time-based gaming method.

### SUMMARY OF THE INVENTION

It is thus one aspect of the present invention to provide a gaming device with a guaranteed amount of playing time. Unlike the complicated methods used in the past to secure greater time on device, this invention is straightforward and easily implemented and additional game time may be won or extended based on a player's success.

The present invention thus promotes player interaction and once initiated, is not “credit” dependent. Thus, this invention is much better than an autoplay device, which is really no better than wedging a toothpick in a play button of an electronic video slot machine. Further, in another aspect of the present invention, a player is only required to make a single wager to play multiple games of a traditional nature. This is a significant improvement over games offering side bets or multiple bets, which require additional betting to receive more credits and time.

It is another aspect of the present invention to provide a gaming device that allows the players to retain all of their winnings during the purchased game time or session, thus incorporating all of the thrills of a slot tournament promotion without staff administration. More specifically, additional credits are no required to play subsequent games within the pre-purchased time cycle or session. Thus, all wins are retained and accumulated and are not dwindled away by additional wagering requirements. In a preferred embodiment, a player does not compete against other players, but plays directly against the house and the player keeps all of the winnings.

Furthermore, the present invention simplifies betting and payouts. In one embodiment, all paylines are automatically covered and the payouts are in dollars and cents, thus there is less confusing math related to credit multipliers for players to evaluate. This methodology simplifies and speeds play, thus promoting a favorable gaming experience for players.

In yet another aspect of the present invention, a skill component is added to traditional gaming experience. To maximize winnings, players must achieve predetermined goals within a certain amount of time, within a certain number of spins or within a predetermined subset of the game session or cycle. To receive the most games possible per unit of time, players must initiate games as fast as possible. A more successful player may obtain more opportunities than a slower player within the allotted time frame. This additionally may satisfy the requirement that games involve skill which is required for approval in certain gaming jurisdictions.

It is another aspect of the present invention that the gaming experience be highly interactive. Thus, the game requires players to be there physically to start each and every game within the purchased time period to get the most for their money. This interaction insures a higher level of player involvement.

It is still yet another aspect of the present invention to provide a new play method that may be applied to nearly any existing gaming device. The purchase of a variable play session instead of individual or prepaid games, may be offered in virtually any gaming device, whether mechanical, video reel or otherwise. It works equally well in video poker, video blackjack and other gaming types. Accordingly, most existing play methods remain unchanged and are thus cost effective for casinos. Operators and manufacturers may also benefit by leveraging existing game themes, copyrights and trademarks because it is relatively easy to retrofit existing slot machines by use of an appropriate timing means, and by pricing play time (the wager) appropriately to achieve an acceptable profit to operators and an acceptable return to players. Most gambling games in casinos today may use the present invention with a timer means and appropriate software, firmware, or hardware. The purchase of time on device instead of buying a game or games, may be employed in innumerable gambling situations.

It is yet another aspect of the present invention to provide a gaming device that may be useful in gaming markets where “loss limits” are in effect. In the Netherlands, for example, games must be designed so that the expected loss rate does not exceed 50 guilders per hour. Thus, this invention simplifies regulatory compliance with time standards and loss limits in certain gaming jurisdictions.

It is another aspect of the present invention that the gaming methodology may be useful in dealing with problem gamblers. More specifically, by defining in advance the cost of play for a given period, players are less likely to get carried away with their betting. Today it is often difficult for players to assess the cost of playing over extended periods of time, since that requires timing individual games, monitoring play rates, and tracking wagers which casual players are ill-equipped to do. In fact, electronic devices to assist players in such assessments are generally prohibited by casino operators. With this invention, a player's monetary risk over time is clearly known in advance. These features would minimize a casino operator's liability related to problem gamblers, as well.

Thus, the present invention offers a player the chance to win additional play time or otherwise lengthen their session, granting them more winning opportunities. In an alternative embodiment, extended play time is granted for obtaining certain symbols. Unlike simply winning free games, which usually play off automatically, this method of extended play time adds urgency and a skill component, leading to greater excitement.

It is thus an additional aspect of the present invention to lessen a player's risk for the same amount of play, yet provide the same earnings to casino operators. These benefits as compared to a traditional slot machine game are shown in the following example:

Player #1. Some slot machines keep, on average, 10% of monies wagered. If $5 per game is wagered on such a game, and a game takes 5 seconds to play, then player #1 will lose 10% of $5 times 12, or $6.00 each minute on average. Note player #1 has risked a total of $5 each for 12 games, or a total of $60.

Player #2. With the method of the present using this invention, player #2 bets $20 one time only for one minute of play. The slot machine loss rate is adjusted such that, on average, the casino keeps $6 from each minute of play. So, after one minute, player #2 has also lost $6.00.

Results. Both players have lost $6.00. The casino has won the same amount in the same amount of time. However, (A) Player #1's risk was 3 times greater than player #2—$60 vs. $20; and (B) Player #2 has enjoyed longer guaranteed play time—at least 60 seconds. Player #1 could lose $20 in as little as 4 games (taking just 20 seconds).

It is still yet another aspect of the present invention that the gaming device be adapted to allow players to easily assess their winnings and losses More specifically, one embodiment of the present invention allows players to more easily evaluate their wins or losses over a period of time. At the end of their session, players may easily compare their investment to their final return, since, in most embodiments, a player will only bet once per session and accumulated wins are counted automatically. This assessment is not always easy to perform when using coins, currency, or credits won from the credit meter. Thus, the gaming experience is less complicated and easier for players to understand.

Furthermore, the present invention strengthens a player's self image. In recent years, the percentage of a casino's floor devoted to lower denomination machines has increased drastically due to the proliferation of multi-line, multiple coin-per-line video slots. Dollar denominated slot players hold greater esteem than nickel players. While 90-coin nickel players might bet $4.50 per game and $50 per minute or more, they're still perceived as lowly nickel players. Since this invention will usually require a greater initial wager ($20 in the preferred embodiment), but usually less over time, it restores and enhances the psychological self-image of the high roller at a reasonable price.

It is another aspect of the present invention that it minimizes coin handling and speed game play. In one embodiment, the invention requires only a single bet for a minimum number of spins, such as 10. Since the bet decision is only made once, it is effectively 10 times faster to wager. Players may then focus less on inserting coins and more on playing. Thus, the gaming experience is easier and faster to play.

It is still yet another aspect of the present invention to provide a variable session-length slot machine wherein the amount of playing time is substantially random. There are generally three main factors in the area of time-based gaming devices: (A) the wager, which can be thought of as a prepayment for a minimum number of reel spins (or other gaming events), (B) the term or length of the game-play cycle, which may be fixed or variable, and (C) the session termination event(s), which dictates the end of the game play session. With respect to a slot machine, the precise number of spins is normally controlled simply by events within the game itself that may trigger more play time, more spins, and more chances to win. In one embodiment, randomly occurring symbol combinations will trigger extended play. Thus, this embodiment of the present invention has both fixed and variable components. The fixed part, the minimum session length or number of spins, is known at the time of wager, while the variable part is unknown. A game with variable play time then refers to an unknown time period of play or session length for a given wager. In another embodiment, a player plays until they accumulate a predetermined, or possibly variable, number of game-terminating events or symbols, whereupon the game is over. In addition, game-extension symbols or events may be added that counteract game terminating symbols or events, thereby increasing play time for a longer session.

A player of time-based slot machines are effectively pre-paying for a number of slot machine reel spins and associated events. The number of spins may be known at the time of wager, constrained by a timing means such as a game count-down clock, or it may be controlled simply by events within the game itself. A time-based machine might be entirely variable, wherein the time or number of spins a player receives for their wager is entirely unknown. Alternatively, a time-based machine might be partially variable and partially fixed as described above. An example of a typical variable play machine is one in which a player purchases one minute of play time, but events within the game trigger more play time. More specifically, randomly occurring symbol combinations trigger extended play time.

As previously mentioned, there are three main parts to the games contemplated herein: the wager (prepayment), the term of play, and the terminating event. Reel spins and symbol occurrences do not necessarily dictate the actual length of the play cycle. Other aspects within the game may determine termination, and hence the actual amount of play time achieved. For example, spinners, wheels, cards or dice might be used instead of, or in addition to, symbols appearing on reels. These may occur anywhere and at any time within the session. One embodiment of the present invention allows a user to purchase additional time or spins if, for example, a player achieves something of value, such as an advanced level (usually involving a higher expected payback), and they wish to continue play at that level in exchange for an additional investment.

The session length purchased can be infinitely adjusted from one event or more. Of course, depending on the nature of the gambling device, the event may be a spin or roll of the dice, a draw of the cards, etc. The cost of play time (the wager) may also be infinitely adjusted, depending upon the nature of the game. There is no requirement that this invention yield the house or player the same mathematical advantage as any other game, but rather this advantage can be greater, equal to or less than any like or dissimilar gambling device. In fact, there may be no mathematical advantage at all, and various embodiments of this invention may be used as a promotional means.

The nature of the clock function means for timekeeping can also be varied. The game count-down clock can easily be replaced by any device measuring time as in a digital display, LED, video clock, periodic audio (tick tocks or gongs), hourglass or other means.

It should be noted that there is an enormous potential benefit to time-based or session play gaming devices that may not be readily apparent. Some gaming markets in the United States have bet limits. For example, in Colorado there is currently a $5 bet limit on slot machine play. That limit normally applies to each pull of the handle (if equipped), or each spin of the reels, including any embedded features or bonuses. Using this invention, it is possible to design a game that costs $20 to play that meets certain jurisdictional requirements, such as a $5 bet limit, provided that the game assures the player of at least four spins. In fact, one embodiment of a variable play-time slot machine game above would meet such criteria, since it assures the player of at least five spins. More specifically, on a per spin basis the $20 would be reduced to a maximum per spin bet of $4. In these cases, purchasing time is equivalent to a pre-purchase of a certain minimum number of spins.

Another advantage of these buy-a-session games is that they open up a whole new world of gaming device design possibilities. Previously there was virtually no such thing as accumulating wins from multiple reel spins from a single bet, except when free spins were (infrequently) won. It is still yet another aspect of the present invention to provide a gaming device that is adapted to be used in conjunction with video lottery terminals. More specifically, one embodiment of the present invention is adapted to be played on video lottery, Paramutual, or other types of gaming devices that are networked with a centralized computer server.

Thus, it is one aspect of the present invention to provide a method of playing a gaming machine comprising the steps of:

a) initiating a variable period of play for a game operating on the gaming device;

b) displaying a plurality of parameters related to said game;

c) interacting with a player of said game through data selectively entered by the player;

d) displaying at predetermined times at least one game-terminating symbol;

e) providing a storage means that is adapted to store information related to said game;

f) determining an outcome of said game based on information stored in said storage means of said gaming device;

g) displaying game results periodically; and

h) ending said variable period of play when a predetermined number of game-terminating symbols occur.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1 is a front elevation view of one embodiment of a video gaming device incorporating the present invention;

FIG. 2 shows an example of the play buttons in one embodiment of the present invention;

FIG. 3 depicts one embodiment of a screen display that might be used on a video gaming device which incorporates the present invention;

FIG. 4 depicts a screen display for another embodiment of the present invention;

FIG. 5 depicts a screen display for yet another embodiment of the present invention;

FIG. 6 is a flow chart which shows one embodiment of a method of providing a time-based slot machine;

FIG. 7 is a flow chart that shows another embodiment of a method of providing a variable time-based slot machine that is adapted to terminate a game session upon the occurrence of predetermined events;

FIG. 8 depicts one embodiment of a screen display that is employed by one embodiment of the present invention; and

FIG. 9 depicts a screen display that is employed by another embodiment of the present invention.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

To assist in the understanding of the present invention the following list of components and associated numbering found in the drawings is provided herein.

| # | Component |
|---|---|
| 10 | Gaming device |
| 12 | Credit meter |
| 14 | Sessions wins meter |
| 16 | Time selection button |
| 18 | Clock timer |
| 20 | Game activation button |
| 21 | Reels |
| 22 | Current win meter |
| 23 | Reel 5 |
| 24 | Accumulated win meter |
| 28 | Extended play meter |
| 32 | Game screen |
| 34 | Bonus clock |
| 36 | Progressive paytable |
| 38 | Accumulated spins meter |
| 40 | Termination events meter |
| 42 | Reel window containing 5 reels |
| 44 | Bet button |
| 46 | Session activation button |
| 50 | Termination events remaining meter |
| 54 | Bet meter |

### DETAILED DESCRIPTION

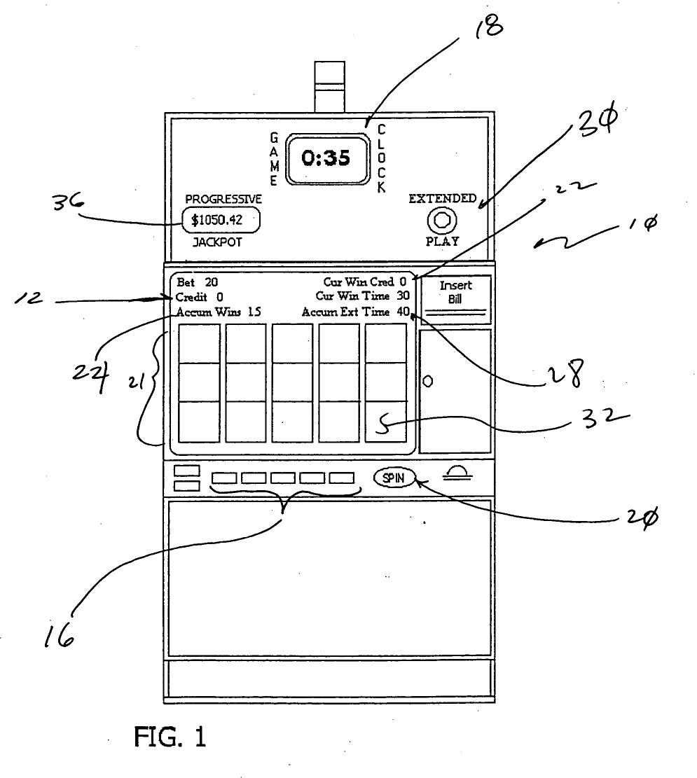

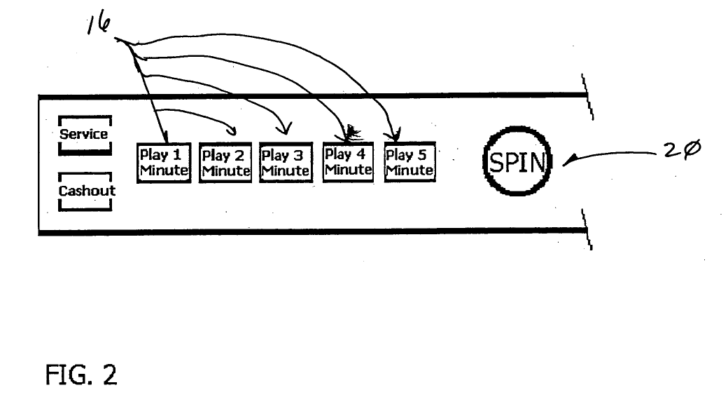

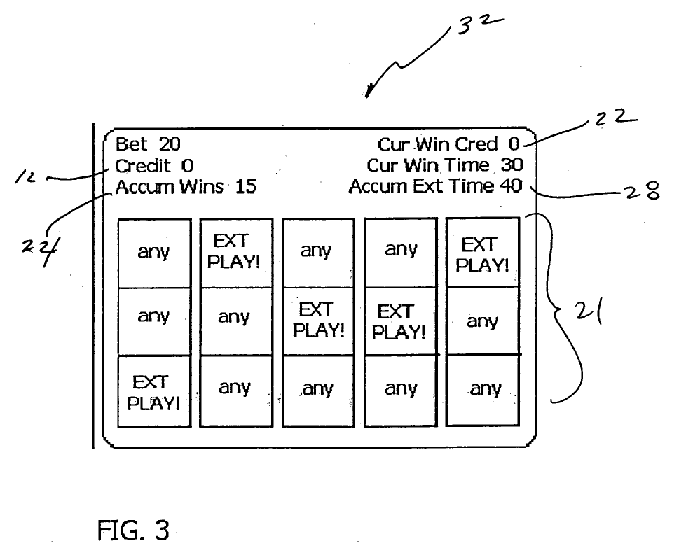

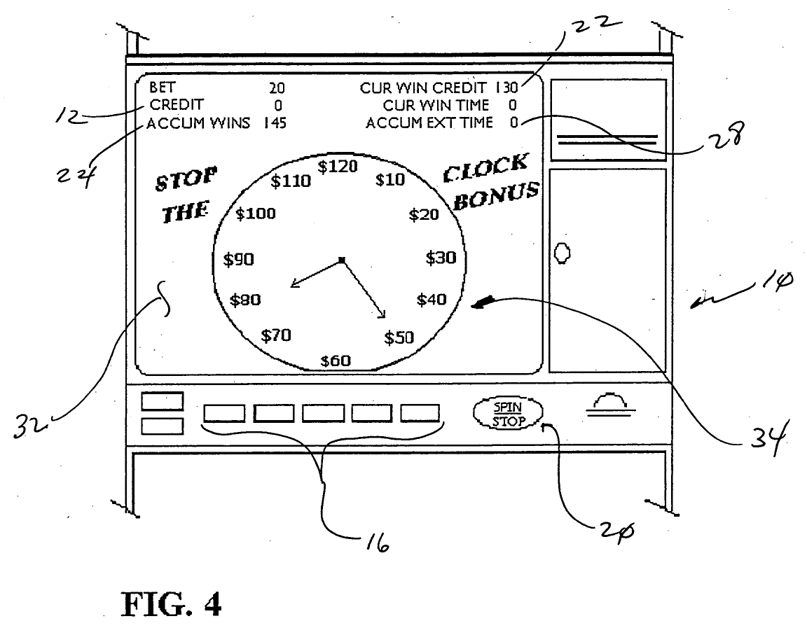

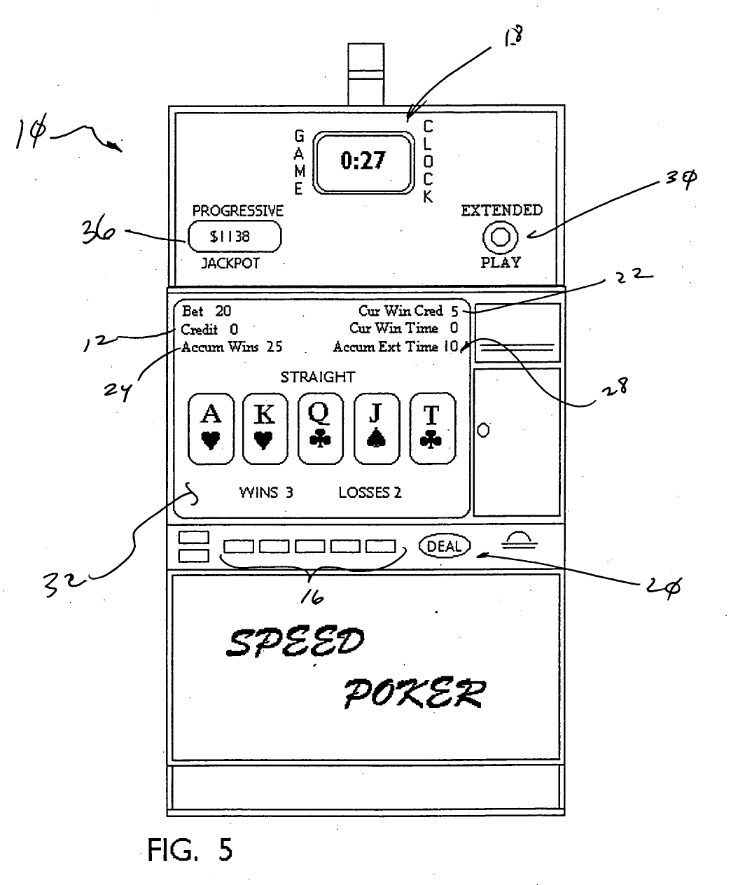

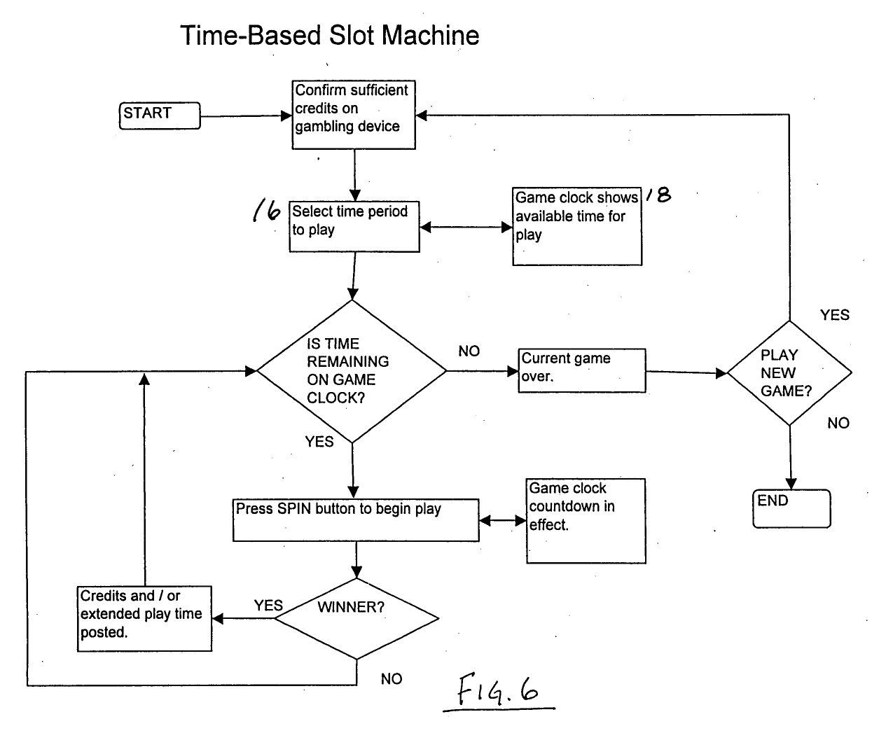

FIGS. 1-9 show a gaming device that is capable of providing a user with variable play time, wherein a plurality of games may be played with a single wager. In addition, the play time may be reduced or expanded pursuant to the occurrence of random symbols or events. The present invention employs a unique and novel method of wagering on slot machines and other gaming devices. Instead of a player purchasing single games individually with coin, credit, or other means, a player buys time. For example, inserting $20 into the machine buys one minute of play. During this minute, the player can play as many games as they can, which thus promotes an enhanced speed of play, opportunity for greater player interaction, and an improved gaming experience. By purchasing time on the gaming device instead of individual games, there is no longer a direct relationship between a single game and the wager. Thus, the present invention guarantees time on device. By purchasing time on a gaming device instead of individual games, players are assured of a certain minimum length of play.

Referring now to FIGS. 1-9, one embodiment of the present invention is shown herein. Initially, a player adds credits to the gaming device 10, for example, by inserting a $20 bill into a currency acceptor, wherein twenty dollar credits are posted to the machine credit meter 12. Next, the player presses a time selection button 16. Twenty credits are deducted from the credit meter leaving a balance of 0. A conspicuously displayed clock timer 18 resets to the selected time. The player presses a prominent game activation button 20, the timer 18 begins counting down and the reels 21 spin. All reels 21 spin and stop sequentially after a predetermined elapsed time, for example five seconds. The resting symbols displayed are evaluated against a paytable to determine any winners. The clock timer 18 continues to run non-stop. Winnings, if any, are posted to a current win meter 22 and are also accumulated on an accumulated win meter 24. The player presses the game activation button 20 again initiating the next game, and the cycle repeats until the game clock 18 expires. When the last game started before time expires is finished, accumulated winnings are posted to the credit meter 12 and are available for re-wagering or cashout. Games that are initiated before time expires are normally allowed to finish, and will subsequently pay a player according to the paytable as necessary. Further, all events within the time cycle may be accompanied by suitable audio or video effects such as flashing lights, horns, bells, whistles, etc.

With a fixed amount of time for play, players are motivated to play as fast as they are able. This enhances the gaming experience and encourages more play and enhanced revenues for the gaming establishment. Players will typically start their next game as soon as one ends to get the most games for their money, and may develop different methods in this pursuit. Some players may repeatedly press the game activation button 20 hoping to catch it at the earliest opportunity, while others may wait until the reels 21, or other game specific symbols, are evaluated before pressing the game activation button 20 again. This frenzied style of play adds excitement and greater entertainment value to the gaming experience. As play time nears expiration, audio ticks may increase in volume, and the video machine background may change color, signaling to the player their time is nearly up. Finally, a bell or similar signal sounds when time expires and play is finished. As appreciated by one skilled in the art, any combination of audio or visual enhancements may be utilized during the time of play, or subsequently thereafter which indicates a successful wagering experience or other factors related thereto. At the conclusion of play time, the player may evaluate their winnings against their wager, and they are free to purchase more time by any acceptable means, or to cash out by collecting winnings and discontinuing additional play.

In one alternative embodiment of the present invention, the game is provided with a feature that offers additional play time. For example, the paytable includes a “scatter pay” that triggers extended play time for a predetermined number of a specified symbol landing anywhere onscreen. The extended play time is accumulated on a separate, extended play meter 28 and, upon the expiration of the originally pre-purchased time period, is posted to the game clock 18 and usually immediately credited without any further action by the player. Extended play may be granted in the form of time, additional credits, the reduction of one or more accumulated game terminating symbols or events, credits against future game terminating symbols or events, the restoration of lives lost, additional lives granted or by other means. In addition, a player may purchase extended play in the form of additional time, lives or the like by additional wager.

For example, consider a player buying one minute of play for $20 and on their third spin getting scatter win symbol that pays ten (10) seconds of extended play time. On their fourth spin, they win 15 credits. Further, on their fifth spin they get another scatter pay symbol that pays 30 seconds of extended play time. At this point, 40 seconds are accumulated and displayed on the accumulated extended play meter 28. At the end of regular play, this 40 seconds is posted to the game clock 18, the 40 seconds is removed from the extended play meter 28 and play continues uninterrupted for another 40 seconds. Note it is possible to achieve yet another scatter pay winner during these 40 seconds that grants more extended play time, whereupon the cycle repeats. In other words, it is possible to win more extended play while you are in an extended play period. Furthermore, extended play may be accompanied by appropriate audio and video changes such as flashing lights 30 to enhance the extended play experience.

Another embodiment of the present invention employs a bonus game that is embedded within the base game. Here, when at least one special symbol, a clock, for example, appears anywhere onscreen 32 in the base game a second-screen feature game is triggered. Upon triggering the bonus game, the base game timer 18 stops temporarily, so there is no time penalty for playing the bonus. Preferably, in the bonus mode there is a large clock 34 with credit values or dollar values of various amounts replacing the time numerals, and hand(s) of the clock spin rapidly. Pressing a button designated as the stop button stops the hand(s), and the player is paid according to which value the hand(s) are pointing at. Alternatively, the clock movement is initiated by pressing the game activation button 20. After posting any winnings to the credit meter 12, base game play is resumed and the base game timer 18 continues its count down from where it left off. The second screen features and other bonuses are embedded within the game, and in one embodiment cannot be wagered on separate from the base game. In addition, the second screen features do not require a bet of their own since they are only available as a subset of possible occurrences within the base game.

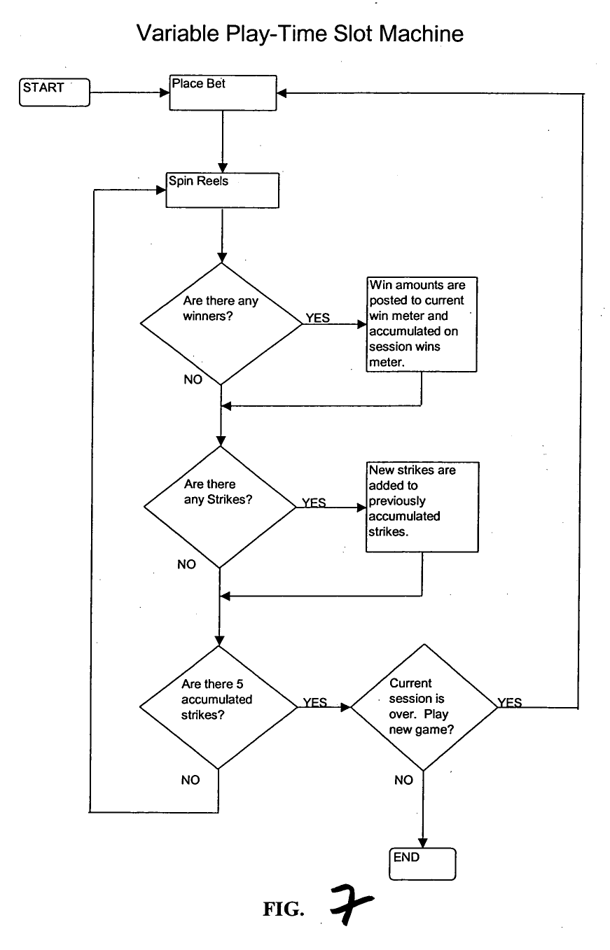

Referring to now to FIG. 7, yet another alternative of the present invention is shown, wherein the pre-purchased time period may be partially or entirely variable. A variable time gaming device is one where the player does not know at the time of wager precisely how much play time or number of plays they'll get for their money. That is the exact amount of play time, the number of slot machine reel spins or other events common to a gaming device are unknown when the bet is placed. One example of a variable time period wager employs a special game-termination feature. Preferably, in one gaming machine embodiment of the present invention, the initial wager enables play for an indeterminate length of time, with play ending only after the player has accumulated a predetermined number of game-terminating symbols over the course of two or more games. Alternatively, on a draw poker embodiment of the present invention, play might terminate only when the player has drawn a predetermined game-terminating card a certain number of times. In a related embodiment of the present invention, game-extension symbols are provided which counteract the game-terminating symbols thereby extending the play time. In a slot machine embodiment of the present invention, preferably, the game-termination symbols are in the form of bombs, wherein five bombs will end the game. In theory, obtaining five bomb symbols could occur in as little as a single spin of the reels on a five reel slot machine. Also in theory, a player might never obtain five bomb symbols, so that infinite play time is achieved with a single wager. In practice, however, the gaming device is designed so that the player on average receives an agreeable number of spins for their bet, that is, an expected play-time. In addition, statistical methods are generally used to ensure a pre-determined house advantage over the long term. Alternatively, a slot machine might grant the advantage to the player if the game is intended for use as a marketing device with the goal being attention, interest and excitement, rather than profits to the operator. These kinds of games are often referred to as “shill” games which draw in onlookers that presumably will play other nearby games hoping to have similar success.

Referring now to FIGS. 7-9 that describe a gaming machine which is capable of providing a user a variable play time session, wherein a plurality of games, spins or opportunities to win is obtained with a single wager. In addition, the play time may be reduced or expanded pursuant to the occurrence of random symbols, random events or other events or symbols obtained, directly or indirectly, through the use of player skill, by additional wager or otherwise. One embodiment of the present invention employs a unique and novel method of wagering on slot machines and other gaming devices. For example, instead of a player purchasing single games individually with coin, credit or other means, a player buys a session of two or more spins of a slot machine. By purchasing a session on the gaming device instead of individual games, there is no longer a direct relationship between the wager and a single game. By purchasing a gaming session instead of individual games, players are assured of a certain minimum length of play. Thus, the present invention guarantees minimum time on device.

The pre-purchased time period or session may be partially or entirely variable. A variable time gaming device is one where the player does not know at the time of wager precisely how much play time or number of winning opportunities they will receive for their money. That is, the exact amount of play time, the number of slot machine reel spins or other events common to gaming devices are unknown when the bet is placed. Thus, it is a primary aspect of the present invention that players purchase a variable play time gaming session whose duration is dictated by events unfolding within the game session itself. Accordingly, the amount of play time and the number of chances to win for a given wager becomes a gamble of its own.

The embodiments shown may be combined or modified to create other games or to involve other methods that remain within the scope of this specification. For example, a double scatter pay may be employed such that one set of symbols grants the aforementioned extended play time and another grants the aforementioned second-screen clock feature. Side bets, multiple bets or additional time may also be purchased before, during or after the purchased session. In fact, it is anticipated that players may be offered a chance to continue session play if additional credits are wagered within a certain time after session termination.

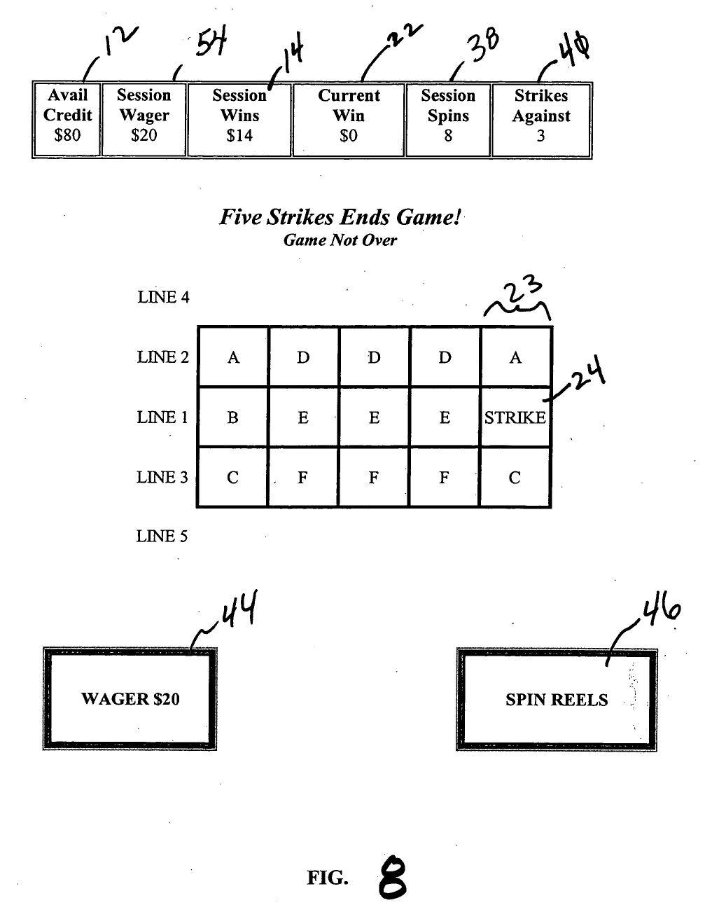

Referring now to FIGS. 7-8, an example of a variable time game are described herein. The variable time version of the present invention, in most embodiments, begins when the player makes a single wager to purchase an unknown number of reel spins, wherein five accumulated termination symbols 24, such as a “strike”, terminate the game play cycle. Preferably, the termination symbols 24 occur only on reel five 23, and the reel is mapped in such a fashion that only one termination symbol 24 can occur on any given spin. Thus, with a typical slot machine showing three positions of each reel, termination symbols 24 are always at least three positions away from each other throughout the reel. After making the wager, the player may spin the reels wherein win credits are posted to a current spin win meter 22 and the number of spins is counted on a session spins meter 38. Further, all wins during the game play session are accumulated on a separate total wins meter 14 (alternatively, a session wins meter). Termination symbols are also accumulated in a similar fashion on a termination events counter 40, so the player knows at any point how many are accumulated. In this embodiment, there is a minimum play of five spins, because it is only possible to get one strike per spin. A game session could be ended in five spins by getting a strike on each consecutive spin. In fact, in many embodiments a minimum spin parameter will be particular to the game to guarantee the player a certain minimum entertainment experience.

The variable time version of one embodiment of the present invention begins when a the player makes a single wager to purchase an unknown number of reel 21 spins, wherein five accumulated bomb symbols terminate the game play cycle. Preferably, the bomb symbols occur only on reel five 23, and the reel 21 is mapped in such a fashion that only one bomb symbol can occur on any given spin. Thus, with a typical slot machine showing three positions of each reel 21, bombs are always at least three positions away from each other throughout the reel 21. After making the wager, the player may spin the reels wherein win credits are posted to a current spin wins meter 22. Further, all wins during the game play cycle are accumulated on a separate total wins meter. Bomb symbols are also accumulated in a similar fashion, so the player knows at any point how many they have accumulated. To add more factors to the game, another related embodiment employs a game-extension symbol, preferably in the form of a United States Coast Guard vessel, on reel 21 five. When the game-extension symbol appears it counteracts, that it removes, one or more of the game-terminating bomb symbols. Thus, a player keeps spinning the reels 21 hopefully accumulating wins while watching the interplay of accumulating bomb and coast guard symbols. In this embodiment, there is a minimum play of five spins, because it is only possible to get one bomb per spin. A game cycle could be ended in five spins by getting a bomb on each consecutive spin. In fact, in many embodiments a minimum spin parameter will be particular to the game to guarantee the player a certain minimum entertainment experience.

In still yet another embodiment of the present invention there is a relationship between the number of spins and the amount of time a player will receive, but that relationship is specific to the game being played. In games employing a count-down clock or timing means, an optimal number of spins is found which is used to find the maximum statistical average payback possible to players. In games not employing a count-down timing means or that require player interaction, actual play times may be highly variable and time itself may not be important to the game. Especially in the case of slot machines with second-screen bonuses and other embedded features that require player interaction, the relationship between time and spins may vary greatly.

Another alternative embodiment, and perhaps one more easily understood in the United States, would be a baseball-themed slot machine game. Accumulating three random strike symbols would constitute one out and upon achieving three outs the game play cycle would be ended. In such a game the player is assured of at least nine spins.

In another embodiment of the present invention, a player may purchase a variable play session without the explicit use of game termination symbols. A minimum number of winning opportunities with the session, such as slot machine reel spins, may simply be assured at the time of wager, and random, regular or irregular game extension symbols or events may extend the session to achieve more variable play time. In this case, game termination symbols or events are simply implied as being equivalent to slot machine reel spins. For example, a bet of $5 might guarantee at least 5 spins on a slot machine. Achieving certain symbols or other events, random or otherwise, may simply grant one or more additional spins, other chances to win or otherwise extend the play session. This embodiment has the advantage of deflecting player attention from session termination to extension.

Yet another related embodiment exploits the plus/minus interplay of game-termination symbols to a more advanced level. For example, an American football game is equipped with a second video display featured prominently above the main reel display to show a football field and to mark simulated players progress thereon. The base game display shows reels that are mapped with a set of a plurality of symbols such as first down, safety, field goal, touchdown, punt, fumble and end of quarter. These symbols may be dynamic and change depending on the situation. For example, on the initial spin of the reels, the symbols might be shown as 0 yards, 5 yards, 10 yards, 15 yards, 20 yards, touchdown and fumble. At least one of these special dynamic symbols might occur on any spin. On wagering, the second display will show a football game kickoff routine. The player will then receive the ball and advance (or not) depending upon which dynamic symbol occur as they spin. The second display shows the player's position and progress (or lack thereof) on a simulated football playing field. On subsequent spins, not only does the player have a change of accumulating winnings but they also may advance down the football playing field in an attempt to earn additional points. If the player receives a symbol that denotes a fumble or a punt, they lose possession temporarily and must recover it by means of another dynamic symbol set for example, interception, fumble recovery, blocked punt, take over on downs, etc., that replaces the current dynamic symbol set. Each spin without possession may also cause the opponent to move the ball and possibly score. When the game is over, evidenced by a fourth quarter end symbol, the player is paid the total of their point score, or alternatively, the number that their point score exceeds that of the computer opponent. Alternatively, the player's point score is a multiplier, multiplying all spin wins by the current total points. Clearly, this level of involvement would be entertaining and demonstrates the potential of gaming devices employing the bet-once, play-many spins concept inherent in this gaming invention. Furthermore, this football embodiment employs a complex set of possibilities that adds an enormous amount of player interaction. Although there are second-screen features and bonuses on traditional slot machines that can be similarly complex, such as The Game of Life™ that occasionally lets players use a spinner to play a video form of the board game, it must be noted that in the prior art these are special bonuses that occur only approximately every 25 to 100 games played. They cannot be wagered on directly, and they only come up infrequently. If viewed alone, these bonus games virtually always return a payback to players exceeding 100%. They are used as an enticement. Conversely, in the present invention the more complex features of the variable play-time game is integral, they are thus wagered on directly, they are achieved with every wager, and each session and they would never normally return more than 100% unless used as a shill game.

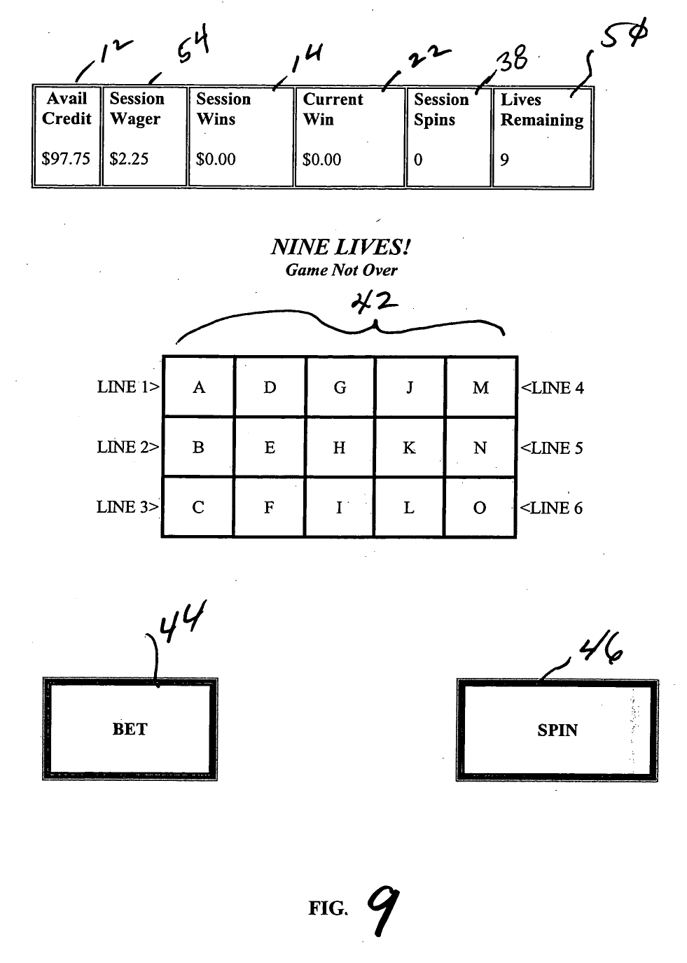

Referring now to FIG. 9, another embodiment of the present invention is shown herein. More specifically, instead of accumulating termination symbols on the reels directly, a player may begin by purchasing a predetermined or variable number of lives. In the example shown each life costs a quarter. Session play ends only when all lives are lost. In this embodiment, a separate video game is played concurrently on a separate display where game terminating symbols or events occur and lives are lost.

Initially a player inserts money, such as $100, into the gaming device, and one hundred dollar credits are posted to the machine credit meter 12. Next, the player presses a bet button 44 nine times betting nine quarters. Two dollars and twenty five cents ($2.25) are deducted from the credit meter 12 leaving a balance of $97.75. The bet meter 54 records the wager, $2.25. For each quarter bet the player has purchased a life, the count of which is displayed on a lives remaining meter 50, which is effectively the number of game termination events allowed per session. The remaining meters reset to zero. The player presses a prominent game activation or spin button 46 and the reels 42 spin. All reels 42 spin and stop after a predetermined or random elapsed time. The resting symbols displayed are evaluated against a paytable to determine any winners. Winnings, if any, are posted to a current win meter 22 and are also accumulated on an accumulated win meter 24 or a session win meter. Each spin of the reels 42 drives events in a secondary game (not shown), where lives may be lost or otherwise affected and where other events may occur. The player presses the game activation button 46 again initiating the next game, and the cycle repeats until the player accumulates the number of predetermined game termination events allowed (in this case, loses all lives), at which time all session wins 14 are posted to the credit meter 12 and the game session is over. All available credits indicated on the credit meter 12 are available for re-wagering or cashout. Note all events within the session may be accompanied by suitable audio or video effects such as flashing lights, horns, bells, whistles, etc.

Note that game terminating symbols may be reel symbols, indicators or counters, or other events or combinations of events whether obtained in the base game or any other associated game or portion of a game whether played before, concurrently or after the fact, or in second or third-screen bonus rounds (or more). Similarly, lives may be lost or regained in any portion of a play session, as well.

Another embodiment similarly allows players to buy a number of lives that expire due to various events within the game session. However, during the course of the game session, tools are accumulated which may be used in the current or a later game portion. For example, reel five 23 may contain special symbols such as arrows, shovels or dynamite which are accumulated throughout the game session. When the normal game play session is terminated, the player is able to use the gathered tools to assist in a subsequent game portion. As an example only, this subsequent game portion might consist of a video mining game where the player uses the tools to navigate below ground to reach pockets or gold or find jewels that award credits. Similarly, reel symbols or combinations might grant lives to be used in the subsequent game portion. The rules governing acquisition and use of tools may be game specific. For example, symbols or combinations may or may not have to occur on a winning pay line to be acquired or not, as the case may be, and tools or lives may even be granted randomly.

In another embodiment to the present invention a spin-based jackpot, predetermined or progressive, may be offered. For example, a player may be rewarded with additional time, lives or credits for achieving a predetermined number of spins within their session.

In yet another embodiment, a predetermined number of consecutive wins within the session might pay a bonus or progressive jackpot. Alternatively, a consolation prize may be awarded for a number of consecutive non-winning spins.

In a progressive jackpot fashion, the pay schedule or paytable of one embodiment of the present invention may include awards that increase in value depending upon the length of time they have gone uncollected. For example, obtaining a predetermined number of green clover symbols might normally pay a fixed award of $100. With a spin-based progressive, that award might increase by $0.25, or a percentage of wagers, for every spin on the gaming device since the last time it was paid. Depending upon the mathematical hit frequency of the game, this progressive jackpot might have an expected value at payoff of $150 or greater. When it does occur, the award automatically resets to its starting value of $100 and starts incrementing again.

In another embodiment of the present invention, session play may be used with a video draw poker gaming device. Instead of wagering on individual (or multiple) hands of video poker, in this game, referred to as “9 Lives Poker”, players play as many hands of video draw poker as possible before drawing the Queen of Spades nine times. Since draw poker alone inherently requires skill, adding a card constraint may be especially intriguing to the accomplished player. Extended play time, second-screen feature games or other bonuses may be granted for achieving certain cards or hands, a certain number of winning (or losing) hands, successive or not, or even randomly within the pre-purchased session.

Other cards or events may act as the game termination symbol. For example, a 53rd terminator card may be added to the traditional deck. Or, any wild card may be the game termination symbol. This would be especially interesting, since it is desirable in the traditional sense as a substitute for any card, but would be undesirable by shortening remaining play time. Game terminating events in poker embodiments might also occur from secondary event bonus games, concurrently played games such as the American football example given above, or from any combination of winning and losing hands. There is no requirement only a single event constitutes a game terminating symbol. It is envisioned that any spade could constitute a game termination event, or that the termination event itself is not strictly predefined, but dynamic and changing from session to session, or alternatively, changing even within the current session. While these examples of game termination events are illustrated with regard to a poker embodiment, these methods apply equally to embodiments of other types of gaming devices.

In yet another version of 9 Lives Poker, a player may purchase lives that expire upon any losing hand. Thus a losing hand becomes a terminating event. Assuming arbitrarily that nine lives is the maximum purchase at time of wager, any nine losing hands would constitute termination of the game play session. Thus, players play until they lost nine times. This type of poker game may be combined with any other poker nuances, bonuses, features or combinations that the specific game would allow. For example, the poker pay tables may increase in value as each life expires, such that after eight lives are expired, the player is playing for maximum stakes. Alternatively, the increases in pay table values may be stepped in a predefined manner, or substantially random and variable. Pay tables may even increment and decrement. Application to other card games is also anticipated.

The physical workings of typical gaming devices incorporating the invention and embodiments are described herein. First, there is an enclosure which contains the component parts of the gaming device. The enclosure is usually a secured cabinet usually made of steel and typically offered in three styles: the traditional upright cabinet, the slant top cabinet intended only for seated play and the bar top which is fitted into a special cavity in a pre-existing bar. The enclosure and components together comprise a self-contained gaming device.

The cabinet enclosure is fitted with various input and output means. Inputs may be accomplished by inserting coins or currency, paper tickets, smart cards, credit or player's club cards or by pressing buttons, keypads, or touchscreen panels. Alternatively, other electromechanical input means known in the art may be used, such as a joystick. Output means include bells and lights, audio and video, coin, currency or ticket dispensing functions and video monitors or reel displays.

A computer storage means such as an hard drive is typically locked inside of the cabinet and is not physically accessible to players. This hard drive stores critical game information such as the game program itself, random number generation means, game results and accumulated statistics. Other common computer data storage means are often used in addition to or instead of a hard drive. For example, critical logic and storage functions may be performed by or in conjunction with a CD-Rom drive, PROM (programmable read-only memory), promdisk (a computer chip that acts as a hard drive), RAM (random access memory) or other means. Computer network means may also accomplish any or all game functions remotely.

Newer gaming devices may accept credit cards, or encoded player cards as, or in lieu of, legal tender. In these cases a card reader is secured inside the cabinet in such a manner so that players may insert their cards from the device exterior. Credits may be deducted from the cards balance and posted to the gaming device, enabling it for play. Player card balances are often increased depending on the amount of game play. For example, a player might earn $5 for every $1000 wagered through participation in a casino's player's club, and that $5 may be posted to a player's card directly. Winnings may also be posted to a player's card.

A display monitor is also secured inside the cabinet so to be visible to the player. The display monitor is primarily an output device, or a means to report game progress and results to players. However, in the case of newer machines, a monitor may be fitted with a touchscreen device that acts as an input medium. Players may thereby make their wagers or other game selections by touch instead of by button. Not all gaming devices are in video form, however, and mechanical reels or other means may replace a display monitor as an output device.

This invention may employ a clock or timing means. A traditional clock, digital timer or other means may be built into the device enclosure to time game play and report time remaining to players. Alternatively, said timing means may be displayed on the video monitor.

Another output function relates to dispensing wins. Most gaming devices include a coin hopper mounted inside the enclosure to receive and payout coins or tokens. Pressing the cashout button, or the appropriate cashout indicator displayed on touchscreen, results in machine credits being paid out of the gaming device in coins or tokens or by other means.

Note that many new games now are referred to as “ticket in, ticket out”, such that legal tender acceptance means includes the acceptance of paper vouchers. Similarly, ticket printers may provide credit dispensing means. Electronic fund transfers may also be accomplished by networking.

Thus, the gaming device generally comprises an enclosure or cabinet that is generally secured by lock(s) to prevent internal access by players. Upon inserting suitable legal tender or its equivalent into a receiving means, credits are posted to the gaming device. These credits are displayed on an output means, usually a video display monitor, but sometimes an LED or similar display. Touching appropriate buttons make game selections and initiate play. A random number generation program is called which selects an outcome, and that outcome is stored in a data storage means and displayed to the player on a video display or by other type of device according to the nature of the game. Often there are opportunities to improve the outcome as in an embodiment incorporating rules of video draw poker, or as in other forms of this invention whereby additional games may be played with or without rewagering. Sometimes there are secondary event or bonus features that require additional player input(s). When the game or game cycle is ultimately resolved, wins, if any, are posted to the credit meter 10 and are available for rewagering or cashout.

The embodiments shown may be combined or modified to create other games or to involve other methods that remain within the scope of this specification. For example, a double scatter pay may be employed such that one set of symbols grants the aforementioned extended play time and another triggers a second-screen feature game. Side bets, multiple bets or additional time may also be purchased before, during or after the purchased session. In fact, it is anticipated players may be offered a chance to continue session play if additional credits are wagered within a certain time after termination. Advances in computer technology may also be incorporated to accomplish any functions.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A method of playing a gaming device, comprising the steps of:
initiating a variable period of play for a game operating on the gaming device;
displaying a plurality of parameters related to said game;
interacting with a player of said game through data selectively entered by the player;
providing a storage means that is adapted to store information related to said game;
displaying at predetermined times at least one game-terminating symbol;
determining an outcome of said game based on information stored in said storage means of said gaming device;
displaying game results periodically; and
ending said variable period of play when a predetermined number of game-terminating symbols occur.

2. The method of claim 1, wherein the occurrence of said game-terminating symbol is random.

3. The method of claim 1, wherein the occurrence of said game-terminating symbol is related to said data selectively entered by the player and said information stored in said storage means.

4. The method of claim 1, further comprising the step of displaying at predetermined times at least one game-extension symbol that extends said variable period of play by counteracting at least one of said game-terminating symbols when said game-extension symbol occurs.

5. The method of claim 4, wherein said game-terminating symbol is a depiction of an explosive device, and said game-extension symbol is a depiction of a ship, wherein the occurrence of said depiction of a ship counteracts at least one of said depiction of an explosive device.

6. The method of claim 1, wherein said game-terminating symbol is in the form of a strike as used in a baseball game, and wherein when a predetermined number of said strikes occurs, said variable period of play ends.

7. The method of claim 1, further comprising the step of displaying a simulation related to said game.

8. The method of claim 7, wherein said game-terminating symbol relates to a sport and said simulation relates to said sport.

9. The method of claim 1, further comprising the step of displaying at predetermined times at least one game-extension symbol which extends said variable period of play by counteracting at least one of said game-terminating symbols when said game-extending symbol occurs, and wherein said game-terminating and game-extension symbols relate to the sport of American football, and wherein said game-terminating and game-extension symbols are a depiction selected from the group comprising at least one of a yard number, a number of downs, a touchdown, a fumble, a pass, a hand-off, a punt, a field goal, a run, a block, a kick, and a penalty.

10. The method of claim 7, wherein said simulation is dictated by the depiction of said game-terminating and game-extension symbols.

11. A method of playing a gaming device, comprising the steps of:
initiating a session period of play for a game operating on the gaming device;
displaying a plurality of parameters related to said game;
interacting with a player of said game from data selectively entered by the player;
providing a minimum number of game winning opportunities within said session;
providing an information storage means;
determining an outcome of said predetermined game based on information stored in said information storage means of said gaming device;
displaying game results periodically; and
ending said session period of play when said minimum number of game winning opportunities expire.

12. The method of claim 11, further comprising the step of providing at least one game extension symbol that increases said minimum number of game winning opportunities.

13. The method of claim 12, wherein an appearance of said at least one game extension symbol is random.

14. The method of claim 12, wherein an appearance of said at least one game extension symbol is dictated by said data selectively entered by the player.

15. The method of playing a gaming machine of claim 11, wherein said predetermined game is a slot machine game, and wherein said minimum number of game winning opportunities is a minimum number of reel spins granted when said session period of play is initiated.

16. A method of playing a gaming device, comprising the steps of:
initiating a session period of play, wherein a player is granted a predetermined number of game plays for a first game operating on the gaming device;
displaying a plurality of parameters related to said first game;
interacting with the player to initiate one of said predetermined number of game plays;
displaying at least one special symbol during said game plays that are used in a secondary game;
determining an outcome of said first game play;
displaying game results periodically;
ending said session period of play when said predetermined number of game plays expire;
initiating said secondary game, wherein said at least one special symbol dictates an aspect of said secondary game.

17. The method of claim 16, wherein said special symbol is a depiction of an arrow, a shovel, or an explosive device.

18. The method of claim 16, wherein said at least one special symbol is displayed randomly.

19. The method of claim 16, wherein said at least one special symbol is displayed based upon said outcome of said game play.

20. The method of claim 16, wherein said second game includes a mining theme, and wherein said special symbols are depictions of mining tools that allow the player to navigate below a depiction of the surface of the earth to reach prizes.

21. The method of claim 16, wherein said second game is the same game type as said first game, such that said at least one special symbol has the effect of granting additional number of said game plays.

22. A method of playing a gaming device, comprising the steps of:
initiating a session period of play wherein a player is granted a predetermined number of game plays for a game operating on the gaming device;
displaying a plurality of parameters related to said game;
interacting with the player to initiate one of said predetermined number of game plays;
determining an outcome of said game play;
classifying said outcome as a win or a loss;
removing one of said predetermined number of game plays if said outcome is a loss;
providing a pay table, which along with the player's wager, dictates the possible reward for said outcome of a win;
rewarding the player said possible reward if said outcome is a win, while maintaining said predetermine number of game plays;
removing one of said at least one predetermined number of game plays if said outcome is a loss;
displaying game results periodically;
ending play when said predetermined number of game plays are exhausted or when said session period expires.

23. The method of claim 22, further comprising the step of altering said pay table between said predetermined number of game plays.

24. The method of playing a gaming machine of claim 23, wherein the amounts on said pay table are selectively increased upon said outcome of a win, and wherein the amounts on said pay table are decreased upon said outcome of a loss.

25. A method of playing a gaming machine of claim 23, wherein said pay table is altered randomly.

26. The method of claim 23, wherein said pay table is affected by an event within the game.

27. The method of claim 26, wherein said event within the game includes at least one of a player interaction, an addition of money or credit, an attainment of predetermined game symbols, and an attainment of a predetermined game outcome.
